(19) United States
(12) Patent Application Publication
(10) Pub. No.: US 2024/0362854 A1
(43) Pub. Date: Oct. 31, 2024

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Daisuke KATSUMI, Tokyo (JP)

(21) Appl. No.: 18/623,084

(22) Filed: Apr. 1, 2024

(30) Foreign Application Priority Data
Apr. 26, 2023 (JP) 2023-072276

(51) Int. Cl. G06T 15/20; G06F 21/10; G06T 15/04

(52) U.S. Cl. CPC G06T 15/20; G06F 21/1014; G06T 15/04; G06T 2200/24

(57) ABSTRACT

New contents data is generated by using a plurality of pieces of contents data owned by a user as raw material data. The information processing apparatus according to the present disclosure obtains user information indicating a user, obtains a plurality of pieces of contents data whose current owner is the user based on the user information, and generates output control data indicating contents in which rendering results of at least two pieces of contents data among the plurality of pieces of contents data are output and controlled as a time series signal.

### BACKGROUND

### Field

The present disclosure relates to a generation technique of digital contents data.

### Description of the Related Art

There is a blockchain technique to append a non-fungible-token (in the following, called “NFT”) to data of digital contents, such as a digital item within a virtual space or within a computer game, or a digital art work. For example, it is possible for a creator of digital contents (in the following, simply called “contents”) to transfer the right of ownership of the data of contents (in the following, called “contents data”) to another person by appending an NFT to the contents data and transferring the contents data to which the NFT has been appended to the other person. On the other hand, it is possible for the person having obtained the right of ownership of the contents data (in the following, called “owner”) to prove the right of ownership of the contents data because the NFT is appended. Further, it is possible for the owner to use, appreciate, listen to, or view the contents owned by him/herself. U.S. Pat. No. 11,148,058 has disclosed a method of setting the right of ownership to the data of a digital item and a method of controlling the action of a character within a game in accordance with the right of ownership of a plurality of digital items.

However, U.S. Pat. No. 11,148,058 has not disclosed a method of creating new contents data by using a plurality of pieces of contents data owned by a user as raw material data.

### SUMMARY

The information processing apparatus according to the present disclosure includes: one or more processors; and one or more memories storing one or more programs configured to be executed by the one or more processors, and the one or more programs includes instructions for: obtaining user information indicating a user; obtaining a plurality of pieces of contents data whose current owner is the user based on the user information; and generating output control data indicating contents in which rendering results of at least two pieces of contents data among the plurality of pieces of contents data are output and controlled as a time series signal.

Further features of various embodiments will become apparent from the following description of exemplary embodiments with reference to the attached drawings.

### BRIEF DESCRIPTION OF THE DRAWINGS

FIG. 1 is a block diagram showing one example of a configuration of an information processing system according to Embodiment 1;

FIG. 2 is a block diagram showing one example of a hardware configuration of a contents control device according to Embodiment 1;

FIG. 3 is a sequence diagram showing one example of a flow of processing of the information processing system according to Embodiment 1;

FIG. 4 is a diagram showing one example of a data structure of a blockchain according to Embodiment 1;

FIG. 5 is a sequence diagram showing one example of a flow of processing of the information processing system according to Embodiment 1;

FIG. 6 is a sequence diagram showing one example of a flow of processing of the information processing system according to Embodiment 1;

FIG. 7 is a diagram showing one example of a purchase screen displayed by the contents control device according to Embodiment 1;

FIG. 8 is a sequence diagram showing one example of a flow of processing of the information processing system according to Embodiment 1;

FIG. 9 is a diagram showing one example of a viewing screen displayed by the contents control device according to Embodiment 1;

FIG. 10 is a sequence diagram showing one example of a flow of processing of the information processing system according to Embodiment 1;

FIG. 11 is a diagram showing one example of a generation screen displayed by the contents control device according to Embodiment 1;

FIG. 12 is a diagram showing one example of a viewing screen displayed by a contents control device according to Modification Example 3 of Embodiment 1;

FIG. 13 is a diagram showing one example of a generation screen displayed by the contents control device according to Modification Example 3 of Embodiment 1;

FIG. 14 is a diagram showing one example of a function configuration of a contents control device according to Embodiment 2;

FIG. 15 is a sequence diagram showing one example of a flow of processing of an information processing system according to Embodiment 2; and

FIG. 16 is a diagram showing one example of a generation screen displayed by the contents control device according to Embodiment 2.

### DESCRIPTION OF THE EMBODIMENTS

Hereinafter, with reference to the attached drawings, the present disclosure explains some example embodiments in detail. Configurations shown in the following embodiments are merely exemplary and some embodiments of the present disclosure are not limited to the configurations shown schematically.

### Embodiment 1

In Embodiment 1, an aspect is explained in which based on a plurality of pieces of sound data, owner information thereon, and user information, output control data is generated, which indicates contents in which rendering results of at least two pieces of sound data among the plurality of pieces of sound data are output and controlled as a time series signal. The owner information is information indicating the owner of the data (in the following, called “contents data”) of digital contents (in the following, called “contents”) such as sound data. In Embodiment 1, explanation is given on the assumption that the owner information is set to a non-fungible token (in the following, called “NFT”) in a blockchain and managed. By making an effective use of NFT, it is possible to cause contents data to have the one and only value. As one example of the format of NFT, there is a token standard called ERC-721 or ERC-1155. The method of setting, management and the like of owner information is not limited to NFT.

Sound data is created by, for example, using existing tools and represented by the well-known file format, typically such as WAV (RIFF wave form Audio Format). As an example of sound data, in a case of a music event, such as a concert, there is sound data obtained by collecting voices of a vocal and sounds produced by musical instruments, sounds produced by spectators, or the like and digitizing them. Further, in a case of a sport, sound data may be data obtained by collecting sounds produced by players, balls, or spectators and digiting them. Further, sound data may be data created by using a synthesizer, a sampler or the like without collection of sounds. In Embodiment 1, as one example, explanation is given on the assumption that a user owns four pieces of sound data obtained by collecting voices of a vocal, and sounds produced by a guitar, a bass guitar, and a drum and digitizing them.

### <System Configuration>

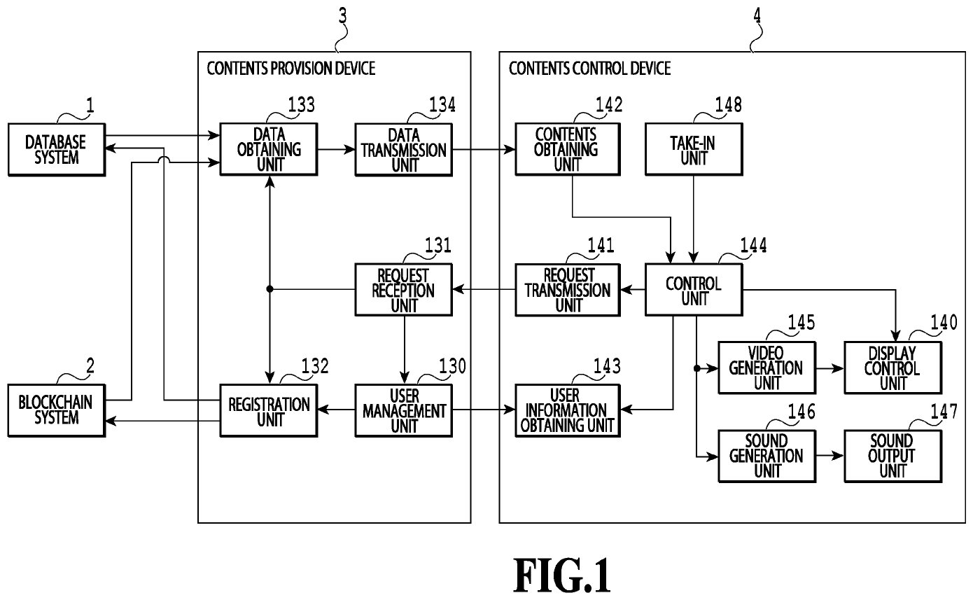

An information processing system according to Embodiment 1 is explained with reference to the drawings. FIG. 1 is a block diagram showing one example of the configuration of the information processing system according to Embodiment 1. The information processing system has a database system 1, a blockchain system 2, a contents provision device 3, and a contents control device 4.

The database system 1 stores and manages a plurality of pieces of contents data, such as sound data, and metadata corresponding to each piece of contents data. Here, the contents data is sound data itself, image data itself or the like, and the metadata is data attached to the contents data. For example, the metadata includes information on the date of the registration of the contents data in the blockchain system 2, the date of the creation of the contents data, the name of the creator of the sound data and the like. In a case where the contents data is sound data, for example, the metadata includes information indicating the name and the like of performers, vocalists and the like. Further, the metadata includes information indicating the sale status, such as the possibility or impossibility of the sale and the selling price, of the contents data. For example, to the sale status, “not for sale” is set as the initial value and the information on the sale status may be changed by the current owner of the contents data. By performing the setting so that the sale status is changed automatically to “not for sale” after the transaction of transfer by buying and selling and the like of the contents data between users, it is possible to suppress the unintended transaction of buying and selling, transfer or the like of the contents data.

The blockchain system 2 records information on new contents data and information (owner information) indicating the owner of the contents data in the blockchain system 2 by a request from the contents provision device 3. Specifically, the blockchain system 2 records contents identification information, such as a contents ID (identifier) for identifying contents data, user identification information, such a user ID for identifying the user, who is the current owner, and the NFT to be appended to the contents data. The number of NFTs determined by the creator of the contents data is issued to the contents data in a case where the contents data information and the owner information are recorded in the blockchain system 2. For example, in a case where the 500 NFTs are issued, it is made possible for up to 500 users to own the contents data. For example, by limiting the number of NFTs, managing the contents data by serial numbers and the like, and so on, in order to increase the asset value of the contents data, it is possible to cause the contents data to have rarity.

The contents provision device 3 registers and stores contents data in the database system 1, obtains contents data stored in the database system 1 from the database system 1, and so on. As shown in FIG. 1, for example, the contents provision device 3 has, as function configurations, a user management unit 130, a request reception unit 131, a registration unit 132, a data obtaining unit 133, and a data transmission unit 134. The user management unit 130 performs new registration, editing, deletion, and management of a user account for uniquely identifying a user. As information managed by the user management unit 130, there is information on the user ID, the name of a user, the role of a user, the financial account for buying and selling contents and the like. As the role of a user, there is a seller who creates and sells contents data, a user who uses contents data, a distributor who distributes contents data or the like.

The request reception unit 131 receives various requests from the contents control device 4 and allocates processing corresponding to the received request to the registration unit 132 or the data obtaining unit 133. For example, in a case where the request from the contents control device 4 is a request to register contents data created by a user in the database system 1, the request reception unit 131 transmits the registration request to the registration unit 132. Upon receipt of the registration request from the request reception unit 131, the registration unit 132 transmits the contents data and the metadata corresponding to the contents data to the database system 1 and causes the database system 1 to store them. Further, in a case where the request is a request to purchase contents data from the contents control device 4 utilized by a user who desires to purchase contents data, the request reception unit 131 transmits the purchase request to the data obtaining unit 133. The data obtaining unit 133 obtains the contents data and the metadata corresponding to the purchase request received from the request reception unit 131 from the database system 1 and transmits them to the data transmission unit 134. The data transmission unit 134 transmits information on contents data based on the contents data and the metadata received from the data obtaining unit 133 to the contents control device 4 utilized by the user.

The contents control device 4 provides the user with a GUI (Graphical User Interface) for performing registration and purchase of contents data, control of viewing and the like of the contents included in the contents data, creation of output control data and the like. It is possible for the user to perform viewing and the like of, for example, the contents included in the contents data owned by him/herself by using the GUI provided by the contents control device 4. As shown in FIG. 1, the contents control device 4 has, as function configurations, a display control unit 140, a request transmission unit 141, a contents obtaining unit 142, a user information obtaining unit 143, a control unit 144, a video generation unit 145, a sound generation unit 146, a sound output unit 147, and a take-in unit 148.

The request transmission unit 141 transmits various requests, such as new registration and management of a user account and new registration, obtaining, purchase and the like of contents data, to the contents provision device 3. The display control unit 140 performs control for displaying various screens on a display, such as a viewing screen of contents included in contents data, a purchase screen of contents data, and a registration screen of contents data. On the viewing screen, an area in which an image, which is results of rendering of contents data, is displayed, a GUI for performing control of display output, sound output, and the like are included. On the purchase screen, an area in which a list of contents data that can be purchased is displayed, a GUI for selecting contents data to be purchased, and the like are included. On the registration screen, the location at which contents data to be registered is stored, a GUI for inputting information on the purchase price, and the like are included. The information input by a user on these screens is sent out to the contents provision device 3 by the request transmission unit 141 along with the corresponding request.

The contents obtaining unit 142 obtains the contents data and the metadata, which correspond to the request to obtain the contents data, from the data transmission unit 134 of the contents provision device 3. The user information obtaining unit 143 obtains the user information managed by the user management unit 130 of the contents provision device 3 from the user management unit 130. The control unit 144 performs control for performing viewing of the contents and the like based on the owner information included in the metadata obtained by the contents obtaining unit 142 and the user information obtained by the user information obtaining unit 143. For example, the control unit 144 transmits the contents data to the video generation unit 145 or the sound generation unit 146 in accordance with the selection operation by a user.

Specifically, the control unit 144 transmits the contents data to the video generation unit 145 in a case where the contents data is image data and transmits the contents data to the sound generation unit 146 in a case where the contents data is sound data. Further, the control unit 144 generates output control data in accordance with the editing operation by a user. Here, the output control data is contents data indicating the contents in which the rendering results of at least two pieces of contents data among the plurality of pieces of contents data obtained by the contents obtaining unit 142 are output and controlled as a time series signal. The contents to be output and controlled are those predefining the appreciation method, the listening method, the viewing method or the like of at least two pieces of contents data (in the following, called “raw material data”) among the plurality of pieces of contents data obtained by the contents obtaining unit 142. Further, the time series signal is a signal for sound output or display output of rendering results of raw material data.

Specifically, for example, in a case where all the raw material data is sound data, in the output control data, information predefining the listening method of the raw material data is included. Further, in a case where all the raw material data is image data, in the output control data, information predefining the appreciation method of the raw material data is included and in a case where sound data and image data are included in the raw material data, in the output control data, information predefining the viewing method of the raw material data is included. More specifically, the output control data is information for reproducing two or more pieces of contents data configuring the raw material data in synchronization and outputting as one video, one sound, or one video with sound. The output control data is described in markup language, for example, such as XML, and does not at all include part or the whole of each piece of contents data configuration the raw material data. By providing a viewer with the output control data such as this, it is possible for the information processing system to provide a viewer with a video, sound, or the like in accordance with the intention of the creator of the output control data while protecting the right of the creator of the contents data configuring the raw material data.

The video generation unit 145 performs rendering for the contents data as the image data obtained by the contents obtaining unit 142 based on the user operation and generates a video as the rendering results. The generated video is transmitted from the video generation unit 145 to the display control unit 140. For example, the video generation unit 145 performs rendering based on the output control contents indicated by the output control data by using the raw material data and the output control data corresponding to the raw material data. The display control unit 140 generates the viewing screen of contents based on the rendering results received from the video generation unit 145 and transmits a signal corresponding to the viewing screen to the display. On the display, the viewing screen corresponding to the signal is displayed.

The sound generation unit 146 performs rendering for the contents data as the sound data obtained by the contents obtaining unit 142 based on the user operation and transmits the rendering results to the sound output unit 147. For example, the sound generation unit 146 performs the rendering based on the output control contents indicated by the output control data by using the raw material data and the output control data corresponding to the raw material data. Upon receipt of the rendering results, the sound output unit 147 generates a sound signal and outputs the generated sound signal to a voice output device, such as a speaker, and causes the voice output device to output a sound wave.

The take-in unit 148 takes in contents data prepared in advance by a user, such as sound data or image data, and transmits the contents data to the control unit 144. The contents data taken in by the take-in unit 148 and the contents data generated by the control unit 144 are stored in the database system 1 via the request transmission unit 141 and the contents provision device 3. Further, information (owner information) indicating the owner of these pieces of contents data, contents identification information and the like are recorded in the blockchain system 2 via the request transmission unit 141 and the contents provision device 3.

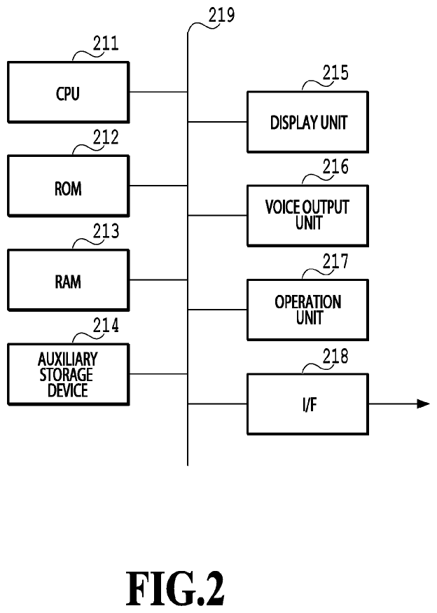

With reference to FIG. 2, the hardware configuration of the contents control device 4 is explained. FIG. 2 is a block diagram showing one example of the hardware configuration of the contents control device 4 according to Embodiment 1. The contents control device 4 has a CPU 211, a ROM 212, a RAM 213, an auxiliary storage device 214, a display unit 215, a voice output unit 216, an operation unit 217, a communication I/F 218, and a bus 219. The CPU 211 implements each function of the contents control device 4 shown in FIG. 1 by controlling the whole of the contents control device 4 by using programs and data stored in the ROM 212 or the RAM 213. It may also be possible for the contents control device 4 to have one or a plurality of pieces of dedicated hardware different from the CPU 411 and at least part of the processing to be performed by the CPU 211 may be performed by the dedicated hardware. As an example of the dedicated hardware, there is an ASIC (Application Specific Integrated Circuit) or the like. The ROM 212 stores programs and the like that do not need to be changed. The RAM 213 temporarily stores programs and data supplied from the ROM 212 or the auxiliary storage device 214 and data and the like supplied from the outside via the communication I/F 218.

The auxiliary storage device 214 includes, for example, a hard disk drive and the like and stores various types of data, such as image data or sound data. The display unit 215 includes a display output device, for example, such as a liquid crystal display or an LED (light-emitting diode), and displays a GUI and the like for a user to operate the contents control device 4. The voice output unit 216 includes, for example, a voice output device, for example, such as a speaker and a headphone, and receives a sound signal and outputs a sound wave. The operation unit 217 includes an operation input device, for example, such as a keyboard, a mouse, a joystick, or a touch panel, and inputs various instructions to the CPU 211 upon receipt of the operation by a user. The CPU 211 operates as a display control unit configured to control the display unit 215 and an operation control unit configured to control the operation unit 217. The communication I/F 218 is used for communication with an external device. For example, in a case where the contents control device 4 is connected with an external device by a wire, a communication cable is connected to the communication I/F 218. In a case where the contents control device 4 has a function to wirelessly communicate with an external device, the communication I/F 218 comprises an antenna.

The bus 219 connects each unit and transmits information. In Embodiment 1, the display unit 215 and the operation unit 217 exist inside the contents control device 4, but at least one of the display unit 215 and the operation unit 217 may exist outside the contents control device 4 as another device. The hardware configuration of the database system 1, the blockchain system 2, and the contents provision device 3 is the same as that of the contents control device 4, and therefore, explanation is omitted.

### <Operation of System>

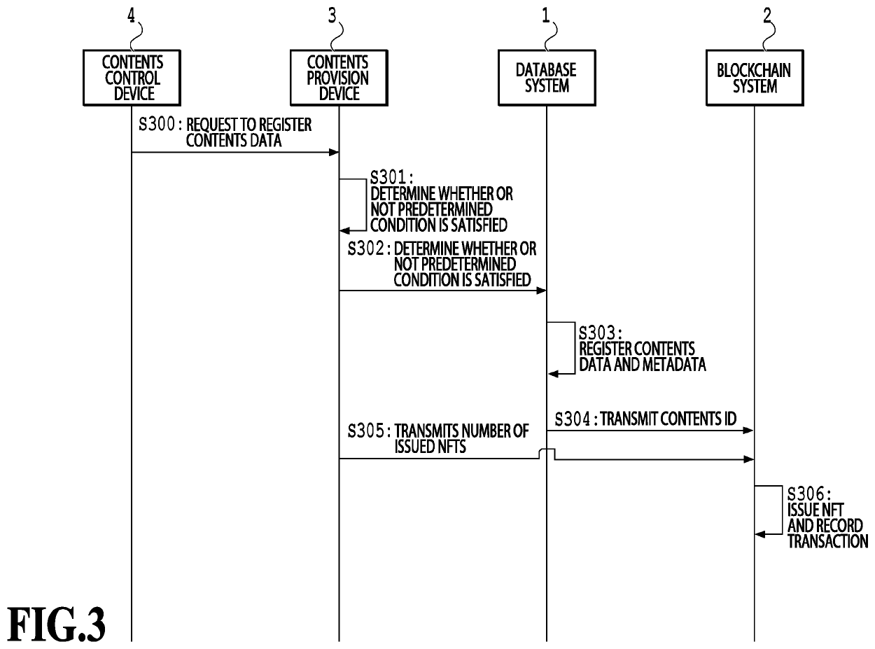

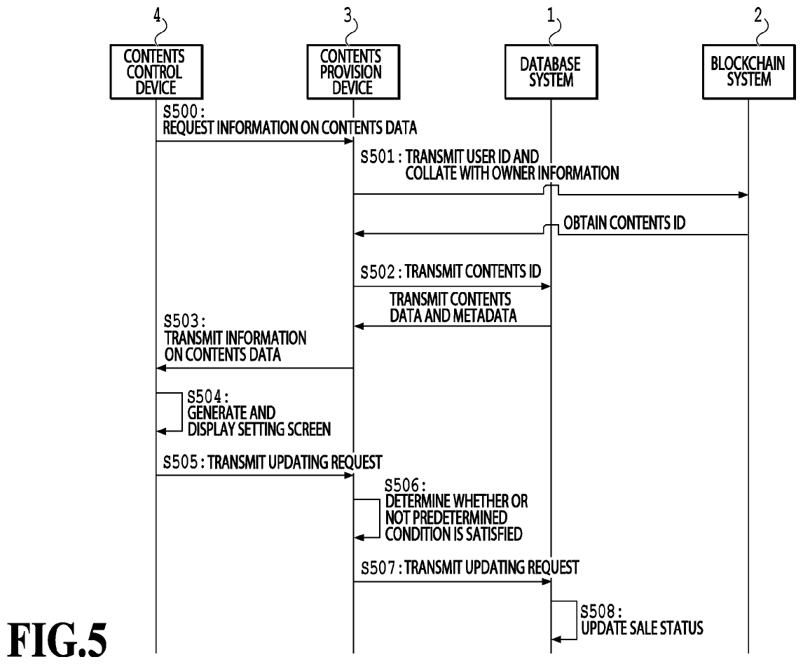

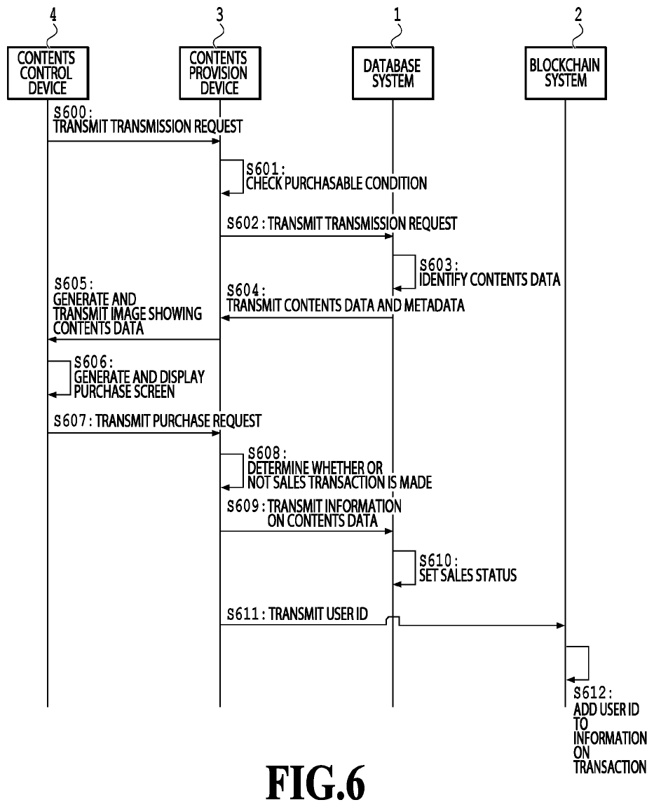

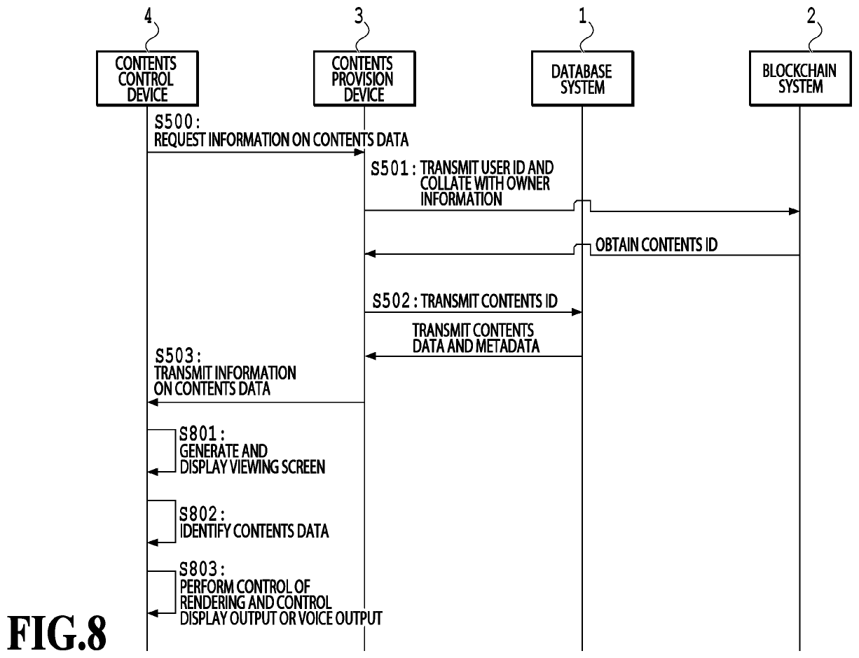

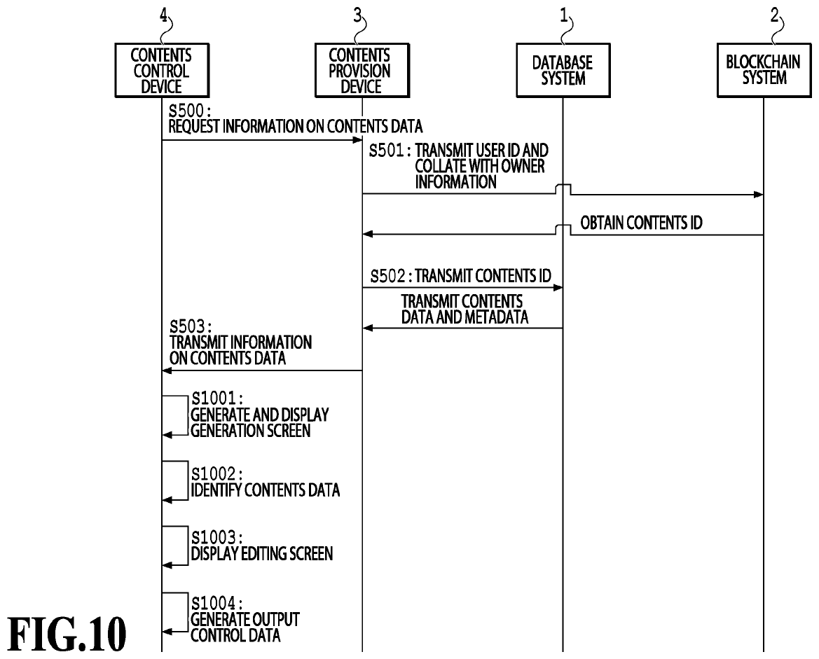

With reference to FIG. 3, FIG. 5, FIG. 6, FIG. 8, and FIG. 10, the operation of the information processing system is explained. FIG. 3 is a sequence diagram showing one example of a flow of processing of the information processing system according to Embodiment 1 and is a sequence diagram showing a flow of processing of the information processing system in a case where contents data is registered in the database system 1. In Embodiment 1, it is assumed that the account of a user who registers contents data is registered in advance and FIG. 3 shows a flow of processing after the login processing by the user operation based on the input of the user ID and password is completed. In the following, explanation is given on the assumption that information on the ID of the user having completed the login processing is stored in advance in the user management unit 130 of the contents provision device 3. Further, explanation is given on the assumption that the target contents data to be registered in the database system 1 is obtained in advance via the take-in unit 148 or generated by the control unit 144 and stored in advance in the contents control device 4.

First, at S300, the request transmission unit 141 of the contents control device 4 transmits a request to register contents data to the contents provision device 3 along with the registration-target contents data and the metadata corresponding to the contents data. The request reception unit 131 of the contents provision device 3 receives the request. It is assumed that in the metadata, information indicating the number of NFTs to be issued to the registration-target contents data is included.

Next, at S301, the request reception unit 131 of the contents provision device 3 determines whether or not the registration-target contents data and the metadata received at S300 satisfy a predetermined condition. Specifically, for example, the request reception unit 131 determines whether or not information indicating the data type and the number of issued NFTs are included in the metadata and in a case where the information is included, the request reception unit 131 determines that the predetermined condition is satisfied. The determination of whether or not the predetermined condition is satisfied is not limited to this.

For example, it may also be possible for the request reception unit 131 to determine whether or not the same data as the received registration-target contents data is already registered in the database system 1 and determine that the predetermined condition is satisfied in a case where the same data is not registered,. In this case, for example, the request reception unit 131 compares the hash value of the received registration-target contents data and the hash value of the contents data already registered in the database system 1. Specifically, in a case where the same hash value as the hash value of the received registration-target contents data exists, the request reception unit 131 determines that the same data as the received registration-target contents data is already registered in the database system 1. In contrast to this, in a case where the same hash value as the hash value of the received registration-target contents data does not exist, the request reception unit 131 determines that the same data as the received registration-target contents data is not registered yet in the database system 1. It may also be possible for the request reception unit 131 to determine whether or not the same data as the registration-target contents data is already registered in the database system 1 based on the estimation results by a learned model estimating whether or not an item is similar. In the following, explanation is given on the assumption that it is determined that the predetermined condition is satisfied.

After S301, at S302, the registration unit 132 of the contents provision device 3 transmits the contents data and the metadata determined to satisfy the condition at S301 to the database system 1 and the database system 1 receives the contents data and the metadata. Next, at S303, the database system 1 registers the contents data and the metadata received at S302 in association with each other and stores the contents data and the metadata in the database. The database system 1 issues a contents ID capable of uniquely identifying contents data in a case of registering contents data and metadata. The contents ID is a serial number or the like allocated to contents data and used in a case where contents data is retrieved or identified in the database system 1. Further, the sale status of the contents data is set to the initial value. By the processing at S303, the registration-target contents data and the metadata are registered in the database system 1.

Next, at S304, the database system 1 transmits the contents ID corresponding to the registration-target contents data, that is, the contents ID issued at S303 to the contents provision device 3 and the data obtaining unit 133 of the contents provision device 3 receives the contents ID. Next, at S305, the registration unit 132 of the contents provision device 3 transmits information indicating the number of issued NFTs included in the metadata received at S300 to the blockchain system 2 and the blockchain system 2 receives the information. Further, the registration unit 132 also transmits information on the user ID stored in the contents provision device 3 and information on the contents ID corresponding to the registration-target contents data to the blockchain system 2 and the blockchain system 2 receives these pieces of information.

Next, at S306, the blockchain system 2 issues NFTs corresponding to the number of issued NFTs to the contents data based on the information on the number of issued NFTs received at S305 and records the transaction. In the transaction, at least, NFTs, the information on the user ID as owner information, and the information on the contents ID corresponding to the contents data are included. In Embodiment 1, it is assumed that in the owner information on the transaction, as the initial value, the user ID of the user having performed the processing to register the contents data is recorded as the first owner. By the processing at S306, it is possible to identify the owner of the contents data registered in the database system 1. After S306, the information processing system terminates the processing of the sequence diagram shown in FIG. 3.

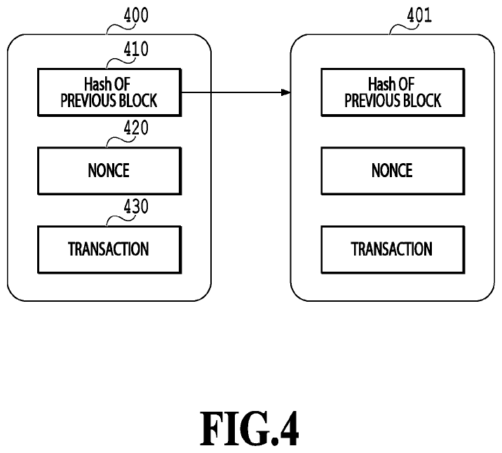

FIG. 4 is a diagram showing one example of the data structure of the blockchain according to Embodiment 1. Each of blocks 400 and 401 indicates a block corresponding to each NFT issued at S306 and although not shown schematically in FIG. 4, blocks corresponding to the number of issued NFTs received at S300 exist. In each block (for example, the block 401), a hash value 410 of the immediately previous block (for example, the block 400), a nonce (number used once) 420, and a transaction 430 are included. The nonce is used for generating a block. In the transaction 430, information on one or more transactions is stored. Specifically, the transaction 430 includes the NFT and the contents ID, corresponding to the contents data, and information (owner information) indicating the owner of the contents data, such as the user ID, as information indicating the transaction of the contents data. Further, in the transaction 430, information on the IP (Internet Protocol) address of the database system 1 for identifying the location of the contents data, or the like is included.

Further, it may also be possible to include the user ID of the creator of the contents data in the transaction. By including the user ID of the creator of the contents data in the transaction, even in a case where the owner changes due to the transaction, such as buying and selling, it is possible to identify the creator of the contents data. It may also be possible to store and register information relating to a smart contract (automatic contract execution to the NFT purchaser) in the blockchain system 2. For example, it is possible to perform the setting so that the equivalent value is paid to the creator each time the contents data is bought and sold, or used by describing the user ID of the creator and information indicating whether or not the resale right is exercised in the smart contract.

FIG. 5 is a sequence diagram showing one example of a flow of processing of the information processing system according to Embodiment 1 and is a sequence diagram showing a flow of processing of the information processing system in a case where the sale status of the contents data owned by a user is set. First, at S500, the request transmission unit 141 of the contents control device 4 transmits a request to obtain information on the contents data owned by the user to the contents provision device 3 and the request reception unit 131 of the contents provision device 3 receives the request. In a case where an obtaining request is made, it is not necessary to request information on all the contents data owned by the user, and for example, it may also be possible to request information on only part of the plurality of pieces of contents data owned by the user.

Next, at S501, the data obtaining unit 133 of the contents provision device 3 transmits the user ID to the blockchain system 2 and collates the user ID with the owner information included in the transaction recorded in the blockchain system 2. Due to this, the contents data owned by the user is identified. In this case, the data obtaining unit 133 obtains the contents ID as information on the identified contents data.

Next, at S502, the data obtaining unit 133 of the contents provision device 3 transmits the contents ID obtained at S501 to the database system 1 and the database system 1 receives the contents ID. Following this, the database system 1 transmits the contents data and the metadata corresponding to the received contents ID to the contents provision device 3 and the data obtaining unit 133 of the contents provision device 3 receives the contents data and the metadata.

Next, at S503, the data transmission unit 134 of the contents provision device 3 transmits the data of the image showing the metadata received at S502 to the contents control device 4 as information on the contents data and the contents obtaining unit 142 of the contents control device 4 receives the data. In Embodiment 1, explanation is given on the assumption that the data transmission unit 134 transmits the data of the image showing the metadata, but it may also be possible for the data transmission unit 134 to transmit the metadata or contents data to the contents control device 4 in place of the data of the image showing the metadata.

Next, at S504, the display control unit 140 of the contents control device 4 generates a setting screen of a sale status by using the data of the image showing the metadata, which is received at S503, and causes the display unit 215 to display the setting screen. A user performs the setting operation of the sale status of the contents data by using the setting screen displayed on the display unit 215. Next, at S505, the request transmission unit 141 of the contents control device 4 transmits a request to update the sale status of the contents data to the contents provision device 3 based on the user operation and the request reception unit 131 of the contents provision device 3 receives the request.

Next, at S506, the request reception unit 131 of the contents provision device 3 determines whether or not the request to update the sale status, which is received at S505, satisfies a predetermined condition. For example, in the contents provision device 3, information indicating a condition of the lowest selling price or the highest selling price of the contents data, and the like is stored in advance and the request reception unit 131 determines whether or not the information on the selling price included in the request to update the sale status satisfies the above-described condition. In the following, explanation is given on the assumption that it is determined that the request to update the sale status satisfies the predetermined condition.

Next, at S507, the registration unit 132 of the contents provision device 3 transmits the updating request determined to satisfy the condition at S506 to the database system 1 and the database system 1 receives the updating request. Next, at S508, the database system 1 updates the information on the sale status of the contents data based on the request to update the sale status, which is received at S507. After S508, the information processing system terminates the processing of the sequence diagram shown in FIG. 5. By the execution of the processing of the sequence diagram, it is possible for a user to set the sale status of the contents data owned by him/herself.

FIG. 6 is a sequence diagram showing one example of a flow of processing of the information processing system according to Embodiment 1 and is a sequence diagram showing a flow of processing of the information processing system in a case where a user purchases contents data. First, at S600, the request transmission unit 141 of the contents control device 4 transmits a request to transmit information on contents data that can be purchased to the contents provision device 3 and the request reception unit 131 of the contents provision device 3 receives the request. In the request to transmit information on contents data, information indicating the retrieval condition of contents data may be included, such as the type, the name or the like of the contents data.

Next, at S601, the request reception unit 131 of the contents provision device 3 checks the purchasable condition of the user, which is managed by the user management unit 130 based on the user account. For example, the contents provision device 3 checks the purchase history of the user and limits part of the purchasable contents data in a case where the number of times of purchase of contents data is two or less. In Embodiment 1, explanation is given on the assumption that the purchasable condition is set in advance for each user account in the user management unit 130, but the setting of the purchasable condition is not indispensable. For example, it may also be possible not to provide the purchasable condition and the purchasable contents data may be determined in accordance with the activity of a user by using a fan token or the like.

Next, at S602, the data obtaining unit 133 of the contents provision device 3 includes the information on the purchasable condition checked at S601 in the transmission request received at S600, and then, transmits the transmission request to the database system 1 and the database system 1 receives the transmission request. Next, at S603, the database system 1 identifies the contents data whose sale status is available for sale. Further, in a case where the information indicating the retrieval condition of contents data is included in the transmission request, the database system 1 identifies the contents data whose sale status is available for sale and which satisfies the retrieval condition. For example, in a case where the name of a piece of music is set as the retrieval condition, the sound data of the piece of music of the name, the data of the captured image obtained by capturing the artist performing the piece of music of the name, or the like is identified as the contents data relevant or corresponding to the retrieval condition.

Next, at S604, the database system 1 transmits the contents data identified at S603 and the metadata corresponding to the contents data to the contents provision device 3 and the data obtaining unit 133 of the contents provision device 3 receives the contents data and the metadata. Next, at S605, the data transmission unit 134 of the contents provision device 3 generates data of the image showing the contents data from the contents data and the metadata received at S604 and transmits the data to the contents control device 4, and the contents control device 4 receives the data. It may also be possible for the data transmission unit 134 to generate the image showing the contents data by using both the contents data and the metadata, or generate the image by using only one of them.

For example, in a case where the contents data is sound data and information on the date of creation and the selling price of the sound data is included in the metadata, the data transmission unit 134 generates an image showing an icon indicating the sound data, the date of creation, and the selling price as the image showing the contents data. In Embodiment 1, explanation is given on the assumption that the data transmission unit 134 transmits the data of the image showing the contents data to the contents control device 4, but this is not limited and it may also be possible to transmit a numerical value, such as the selling price, in place of the data of the image. Further, for example, in a case where the contents data is sound data, it may also be possible for the data transmission unit 134 to include part of the sound data in the metadata and transmit the metadata. Similarly, in a case where the contents data is image data, it may also be possible for the data transmission unit 134 to include data of the thumbnail corresponding to the image data in the metadata and transmit the metadata.

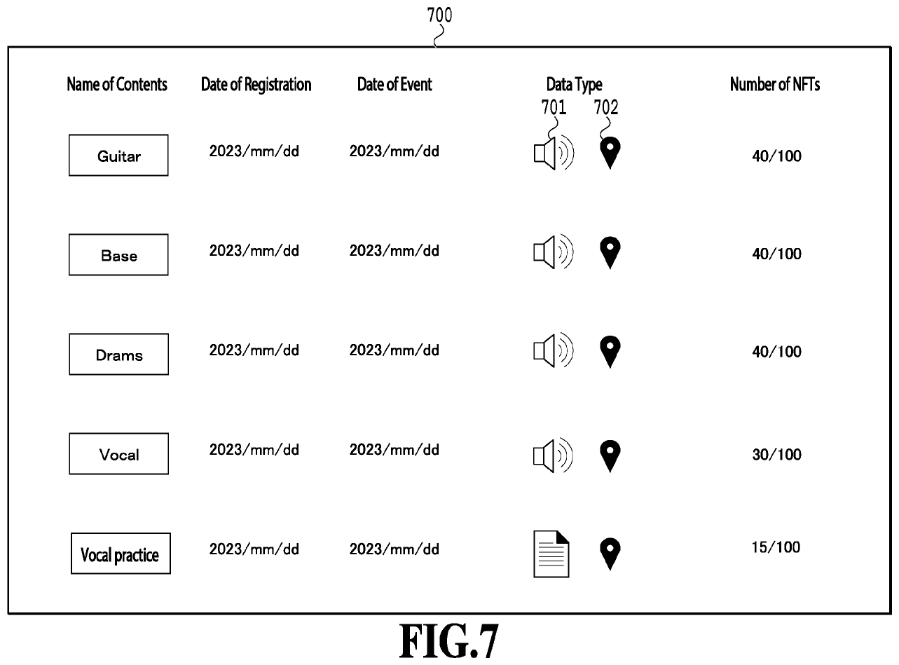

Next, at S606, the display control unit 140 of the contents control device 4 generates a purchase screen of contents data by using the image showing the purchasable contents data, which is received at S605, and causes the display unit 215 to display the purchase screen. In a case where a plurality of pieces of contents data can be purchased, it may also be possible for the display control unit 140 to generate a purchase screen displaying a list of contents data. Details of the purchase screen will be described later by using FIG. 7. Next, at S607, the request transmission unit 141 of the contents control device 4 transmits a request to purchase contents data to the contents provision device 3 based on the user operation and the request reception unit 131 of the contents provision device 3 receives the request. Next, at S608, the request reception unit 131 determines whether or not a sales transaction of contents data is made. For example, in a case where the purchase processing from a user is completed, it is determined that the sales transaction is made. Explanation of the purchase processing is omitted. In the following, explanation is given on the assumption that the sales transaction of contents data is made. Next, at S609, the registration unit 132 of the contents provision device 3 transmits information on the contents data whose sales transaction has been made to the database system 1 and the database system 1 receives the information.

Next, at S610, the database system 1 sets the sale status of the contents data whose sales transaction has been made to the initial value based on the information on the contents data, which is received at S609. Next, at S611, the registration unit 132 of the contents provision device 3 transmits the user ID of the purchaser to the blockchain system 2 and the blockchain system 2 receives the user ID. Next, at S612, the blockchain system 2 adds the user ID received at S611 to the information on the transaction as information for identifying the current owner. After S612, the information processing system terminates the processing of the sequence diagram shown in FIG. 6. By the execution of the processing of the sequence diagram, the sale status of the database system 1 is updated in a case where a user purchases contents data and in the blockchain system 2, a new transaction is recorded.

FIG. 7 is a diagram showing one example of a purchase screen 700 of contents data, which is displayed by the contents control device 4 according to Embodiment 1. In Embodiment 1, explanation is given for an aspect in which contents data is sold for each piece of contents data as one example, but this is not limited. Specifically, it may also be possible for a plurality of pieces of contents data to be sold altogether as one piece of contents data. On the purchase screen 700, for example, information on the name of registered contents data (in the following, called “contents name”), the date of registration of contents data, and the data type of contents included in contents data is displayed. Further, for example, in a case where the contents data is contents data relating to a specific game of a sport competition, a music event, such as a concert, or the like, on the purchase screen 700, information indicating the date of the event is displayed.

In a case where an NFT is appended to contents data, on the purchase screen 700, information on the total number of sales of contents data and the number of remaining pieces of contents data available for sale may be displayed. The total number of sales of each piece of contents data is set based on the number of issued NFTs of contents data. In a case where a user, such as a viewer, performs the user operation to select contents data the user desires to purchase on the purchase screen 700 and determine to purchase, the control unit 144 transmits a request to purchase the contents data and purchase information to the request transmission unit 141. In the following, explanation is given on the assumption that the purchase information is the contents ID of the contents data determined to be purchased.

An icon 701 indicates that the data type of contents is sound data. Further, an icon 702 indicates that information indicating a location is included in the metadata corresponding to the contents data. Further, an icon 710 indicates that the data type of contents is output control data. Here, the output control data is data indicating contents in which rendering results of at least two pieces of contents data are output and controlled as a time series signal. In the following, in Embodiment 1, explanation is given on the assumption that the output control data is data indicating contents in which rendering results of at least two pieces of sound data are output and controlled as a time series signal.

For example, in the contents data whose contents name is “Guitar”, data of the sound of guitar performance among the sound of the piece of music is included. Similarly, in the contents data whose contents names are “Base”, “Drums”, and “Vocal”, the data of the sound of bass guitar performance, the sound of drum performance, and the sound of real voice performance of the piece of music are included, respectively. Further, in the contents data whose contents name is “Vocal practice”, for example, information is included, which is for synchronizing the rendering results of each piece of contents data whose contents names are “Guitar”, “Base”, and “Drums” and outputting and controlling the rendering results as a time series signal.

For example, it is possible for a user having each piece of contents data whose contents names are “Guitar”, “Base”, “Drums”, and “Vocal practice” to perform the following. For example, by using the contents data of “Vocal practice”, it is possible for the user to listen to the sound in which the rendering results of each piece of contents data of “Guitar”, “Base”, and “Drums” are synchronized and synthesized. Due to this, for example, it is possible for the user to practice a song while listening to this synthesized sound, and so on. Details of the output control data will be described later.

In a case where a user performs the user operation to select an icon on the purchase screen 700, for example, it may also be possible for the contents control device 4 to output detailed information on the contents data corresponding to the icon. For example, in a case where the icon indicating that the data type is sound data is selected, the sound generation unit 146 of the contents control device 4 performs rendering of part or the whole of the sound data corresponding to the selected icon. The sound signal, which is the rendering results, is transmitted to the voice output unit 216 and the voice output unit 216 is caused to output the sound signal as sound for a predetermined period of time, for example, such as 20 seconds. Further, for example, in a case where the icon indicating that the data type is output control data is selected, the contents control device 4 performs rendering of part or the whole of the corresponding sound data and causes the voice output unit 216 to output the above-described synthesized sound for a predetermined period of time. By outputting detailed information, it is possible for a user to easily grasp details of the contents of the contents data on sale.

Although not shown in FIG. 7, the data type of contents included in contents data is not limited to sound data or output control data. For example, contents may be an image and may be data indicating a skeleton model indicating the skeleton of an object, or data indicating a three-dimensional shape of an object, such as polygon mesh. Further, for example, contents may virtual camera path information used in a case where a virtual viewpoint image is generated. The virtual cameral path is what indicates a change over time in the position of a virtual viewpoint in a virtual space, the direction of the line-of-sight at the virtual viewpoint, and the like in a case where a virtual viewpoint image is generated. Furthermore, for example, the contents included in contents data may be a background model indicating the shape of the background in the virtual space in which an object exists. Details of the virtual viewpoint image and the virtual camera path information will be described later.

For example, in a case where the icon indicating that the data type is image data is selected, the video generation unit 145 of the contents control device 4 performs rendering of the image data and causes the display unit 215 to display the image, which is the rendering results. Further, for example, in a case where the icon indicating that the data type is three-dimensional shape data is selected, the video generation unit 145 causes the display unit 215 to display an appearance of the shape of the object indicated by the three-dimensional shape data as an image. An aspect in which these pieces of contents data are used will be described later.

FIG. 8 is a sequence diagram showing on example of a flow of processing of the information processing system according to Embodiment 1 and is a sequence diagram showing a flow of processing of the information processing system in a case where a user performs listening, appreciation, viewing or the like of the contents included in the contents data owned by the user. First, in the information processing system, the same processing as the processing at S500 to S503 shown in the sequence diagram in FIG. 5 is performed. After S503, at S801, the display control unit 140 of the contents control device 4 generates a viewing screen for performing viewing or the like of the contents data owned by the user by using the data of the image showing the metadata received at S503 and causes the display unit 215 to display the viewing screen.

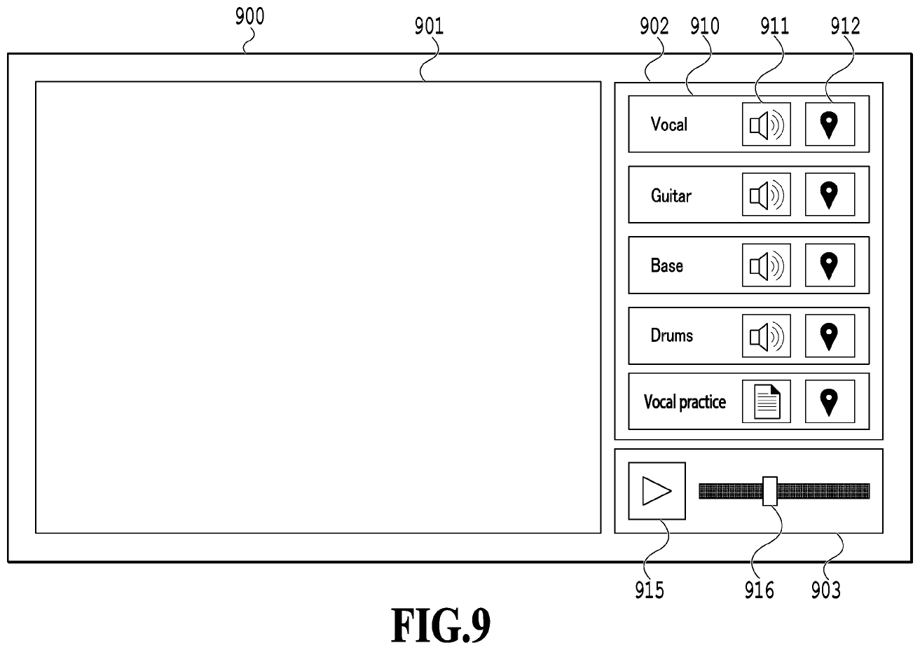

FIG. 9 is a diagram showing one example of a viewing screen 900 of contents data, which is displayed by the contents control device 4 according to Embodiment 1. It is possible for a user to perform control for performing listening, appreciation, viewing or the like of the contents included in the contents data owned by him/herself by using the viewing screen 900. The viewing screen 900 includes an image display area 901, a contents selection GUI 902, and a contents reproduction GUI 903.

The contents selection GUI 902 includes an area 910 in which the contents name is displayed, and icons 911 and 912. The icon 911 indicates the data type of contents data and also plays the role of a button for controlling whether or not to perform rendering of contents data. Further, the icon 912 indicates that information indicating a location is included in the metadata corresponding to the contents data and also plays the role of a button for controlling whether or not to utilize the positional information in a case of rendering of contents data. The contents reproduction GUI 903 includes a button 915 for controlling the display output or the sound output of the contents included in the contents data, and a seek bar 916 for controlling the rendering position (in the following, called “reproduction time”) of contents data.

After S801, at S802, a user performs the user operation to select contents data used for listening or the like and the control unit 144 of the contents control device 4 identifies contents data used for listening or the like based on the user operation. It is possible for a user to perform control to start, terminate, pause, and so on, of the display output or the sound output by performing the user operation for the button 915. In a case where the user operation for the button 915 is performed, at S803, the video generation unit 145 or the sound generation unit 146 of the contents control device 4 performs control of rendering of the contents data identified at S802 and controls the display output or the sound output based on the user operation. Specifically, in a case where the user operation to start reproduction (output) is performed with the button 915 in the state where the contents data whose contents name is “Vocal” is selected, the sound generation unit 146 performs rendering of the contents data. The sound signal, which is the rendering results, is transmitted to the voice output unit 216 and output as sound.

Further, for example, in a case where the user operation to start reproduction (output) is performed with the button 915 in the state where the contents data as output control data, whose contents name is “Vocal practice” is selected, the contents control device 4 performs the following processing. The sound generation unit 146 of the contents control device 4 performs rendering of each piece of contents data as sound data, whose contents names are, for example, “Guitar”, “Base”, and “Drums”, based on the output control data. Further, the contents control device 4 generates a synthesized sound signal obtained by synthesizing the sound signal in synchronization, which is the rendering results of each piece of contents data, based on the output control data. The synthesized sound signal is transmitted to the voice output unit 216 and output as sound.

In the output control data, information on the position (in the following, called “listening position”) at which the sound corresponding to the synthesized sound signal is listened to may be included. For example, in a case where in the metadata of each piece of sound data, which is the base of the synthesized sound signal, information on the position (in the following, called “sound collection position”) at which each sound is collected is included, for example, it may also be possible for the contents control device 4 to generate a synthesized sound signal as follows. In this case, the contents control device 4 generates a synthesized sound signal at the listening position by taking into consideration the delay of sound due to propagation of the sound wave from the sound collection position to the listening position, the attenuation of the sound wave due to the propagation or the like. The generation method of a synthesized sound signal at the listening position such as this is well known, and therefore, detailed explanation is omitted.

By the execution of the processing of the sequence diagram shown in FIG. 8, it is possible for a user to select the content data owned by him/herself and perform listening or the like based on the selected contents data. Further, by utilizing information on the sound collection position and the listening position, it is possible for a user to listen to the sound whose feeling of being at a live performance is stronger. In a case where the contents data selected by a user at S802 is image data, data of a skeleton model, three-dimensional shape data, virtual camera path information or the like, the rendering results based on the contents data are displayed in the image display area 901 as an image. That is, by the execution of the processing of the sequence diagram shown in FIG. 8, it is possible for a user to select the contents data owned by him/herself and perform appreciation, viewing or the like based on the selected contents data.

FIG. 10 is a sequence diagram showing one example of a flow of processing of the information processing system according to Embodiment 1 and is a sequence diagram showing a flow of processing of the information processing system in a case where output control data is generated. First, in the information processing system, the same processing as the processing at S500 to S503 shown in the sequence diagram in FIG. 5 is performed. After S503, at S1001, the display control unit 140 of the contents control device 4 generates a generation screen for generating output control data by using the data of the image showing the metadata received at S503 and causes the display unit 215 to display the generation screen. On the generation screen that is generated at S1001, for example, the contents data owned by the user is displayed in a list.

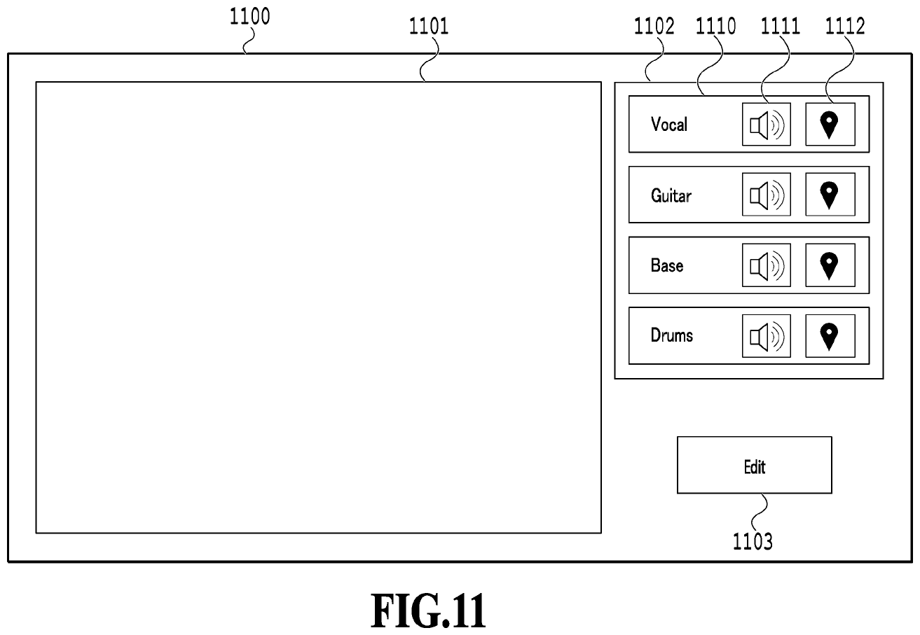

FIG. 11 is a diagram showing one example of a generation screen 1100, which is displayed by the contents control device 4 according to Embodiment 1. It is possible for a user to perform editing of output control data based on the contents data owned by him/herself by using the generation screen 1100. The generation screen 1100 includes an image display area 1101, a contents selection GUI 1102, and an editing button 1103. The contents selection GUI 1102 includes an area 1110 in which a contents name is displayed, a button 1111 for selecting contents data used in a case where output control data is edited, and a button 1112 for controlling whether or not to utilize positional information in a case where output control data is edited.

After S1001, at S1002, a user performs the user operation to select contents data used in a case where output control data is edited and the control unit 144 of the contents control device 4 identifies the selected contents data based on the user operation. It is possible for a user to cause an edition screen of output control data, which is not shown schematically, to be displayed by performing the user operation for the editing button 1103. In a case where the user operation for the editing button 1103 is performed by a user, at S1003, the display control unit 140 of the contents control device 4 generates an editing screen of output control data and causes the display unit 215 to display the editing screen. Here, the editing screen not shown schematically has, for example, the similar GUI as that of a general music editing software application and on the editing screen, for example, the signal of each piece of sound data as raw material data is displayed as the signal of a track. A user performs editing to synchronize the signal of each piece of sound data by using the editing screen. In the editing to synchronize a signal, for example, the setting of the delay period of time of each signal, tempo, volume, synthesis ratio of sound, listening position or the like is included.

In a case where a storage button, a completion button or the like is pressed down by the user operation on the editing screen not shown schematically, at S1004, the control unit 144 of the contents control device 4 generates output control data corresponding to the editing contents at the point in time of the pressing down of the button. In the output control data, information (contents ID) for identifying raw material data is included. Further, it may also be possible for the output control data to include synchronization information, such as the delay period of time for synchronizing each of the rendering results with one another, and the tempo. Further, in a case where sound data is included in the raw material data, it may also be possible for the output control data to include the volume level of the sound corresponding to each piece of sound data included in the raw material data, synthesis information, such as a synthesis ratio of each sound in a case where a plurality of sounds is synthesized or the like. Furthermore, it may also be possible for the output control data to include information indicating the listening position. The control unit 144 generates, for example, output control data describing these pieces of information in markup language. The markup language is just one example and the output control data is not limited to that described in the markup language.

As above, according to the contents control device 4, it is possible for a user to generate output control data as new contents data by using a plurality of pieces of contents data owned by him/herself as raw material data. In the above, explanation is given on the assumption that the output control data is generated based on the editing operation of a user using the editing screen not shown schematically, but the generation method of output control data is not limited to this. For example, it may also be possible for the control unit 144 to generate output control data by inputting a plurality of pieces of sound data, which is raw material data, to a learned model created in advance by machine learning or the like, and obtaining output control data output by the learned model.

After S1004, by performing the processing of the sequence diagram shown in FIG. 3 by taking the generated output control data as registration-target contents data, the output control data is registered in the database system 1. Further, by performing the processing of the sequence diagram shown in FIG. 5, the sale status of the output control data is set in the blockchain system 2. Due to this, the output control data is made public in a state where the output control data can be transferred to a viewer including the owner of the raw material data.

In a case where a viewer has the right of ownership of the output control data and the raw material data corresponding to the output control data, it is possible for the viewer to perform sound output or display output based on the output control data. Here, output control data not including part or the whole of each piece of contents data configuring the raw material data is generated. Due to this, it is possible to provide a viewer with a new reproduction method of contents data based on the raw material data while protecting the right, such as the copyright of the creator of the raw material data.

Up to this point, explanation is given on the assumption that part or the whole of each piece of contents data configuring the raw material data is not included in the output control data, but it may also be possible for the output control data to include part or the whole of at least one piece of contents data configuring the raw material data. In this scenario, it is sufficient to perform the setting for the blockchain system 2 so that, for example, in a case where the sales transaction of the output control data including part or the whole of at least one piece of contents data configurating the raw material data is made, the relevant equivalent value is paid to the creator of the raw material data. For example, in the smart contract, the user ID of the creator of the raw material data and information indicating whether or not to exercise the resale right are described. Due to this, it is possible to perform the setting so that each time the sales transaction of the output control data including part or the whole of at least one piece of contents data configuring the raw material data is made, the equivalent value is paid to the creator of the raw material data. As a result, it is possible to provide a viewer with a new reproduction method of contents data based on the raw material data while protecting the right, such as the copyright of the creator of the raw material data.

### Modification Example 1 of Embodiment 1

In Embodiment 1, explanation is given by taking a case where the raw material data is sound data as an example. In Modification Example of Embodiment 1, a case where the raw material data is image data, particularly, a case where the raw material data is still image data is explained. In this case, for example, the display control unit 140 of the contents control device 4 generates, for example, an editing screen having the similar GUI as that of a general slideshow editing software application at S1003 and causes the display unit 215 to display the editing screen. A user performs editing of timing at which a still image is displayed and output, which is the rendering results of each piece of still image data included in the raw material data, by using the editing screen. It may also be possible for a user to edit display effects in a case where a still image is displayed, subtitles, transitions, BGM (background music) or the like on the editing screen. Further, the data of BGM may be contents data as the sound data owned by him/herself, which is selected as one piece of the raw material data.

In a case where the raw material data is still image data, in the output control data, for example, information indicating timing at which the display of the rendering results of a plurality pieces of still image data included in the raw material data is controlled is included. Further, in the output control data, information on display effects in a case where a still image is displayed, subtitles, transitions, BGM or the like may be included. Moving image data may be included in the raw material data. In this case, in the output control data, for example, information indicating timing at which the display of the rendering results of the moving image data included in the raw material data is controlled is included.

In the above, the explanation is given on the assumption that the output control data is generated based on the editing operation of a user using the editing screen not shown schematically, but the generation method of output control data is not limited to this. For example, it may also be possible for the control unit 144 to generate output control data by inputting a plurality of pieces of image data included in raw material data, or a plurality of pieces of image data or sound data to a learned model created in advance by machine learning or the like, and obtaining output control data output by the learned model.

In a case where a viewer has the right of ownership of the output control data and the raw material data corresponding to the output control data, it is possible for the viewer to perform display output, such as a slideshow, based on the output control data. Here, output control data not including part or the whole of each piece of contents data configuring the raw material data is generated. Due to this, it is possible to provide a viewer with a new reproduction method of contents data based on the raw material data while protecting the right, such as the copyright of the creator of the raw material data. The output control data may include part or the whole of at least one piece of contents data configuring the raw material data. In this scenario, it is sufficient to perform the setting for the blockchain system 2 so that, for example, in a case where the sales transaction of the output control data including part or the whole of at least one piece of contents data configurating the raw material data is made, the relevant equivalent value is paid to the creator of the raw material data. Due to this, it is possible to provide a viewer with the display such as a slideshow as a new reproduction method of contents data based on the raw material data while protecting the right, such as the copyright of the creator of the raw material data.

### Modification Example 2 of Embodiment 1

In Modification Example 1 of Embodiment 1, the explanation is given by taking a case where the raw material data is a still image as an example. In Modification Example 2 of Embodiment 1, a case is explained where the raw material data is moving image data. In this case, for example, the display control unit 140 of the contents control device 4 generates, for example, an editing screen having the similar GUI as that of a general moving image editing software application at S1003 and causes the display unit 215 to display the editing screen. A user performs editing of the timing at which a moving image, which is the rendering results of each piece of moving image data included in the raw material data, is displayed and output by using the editing screen. It may also be possible for the user to edit display effects in a case where a moving image is displayed, subtitles, transitions or the like. In a case where the raw material data is moving image data, in the output control data, for example, information indicating the timing at which the rendering results of a plurality of pieces of moving image data included in the raw material data are displayed and controlled is included. Further, in the output control data, information on display effects in a case where a moving image is displayed, subtitles, transitions or the like may be included.

In the above, the explanation is given on the assumption that the output control data is generated based on the editing operation of a user using the editing screen not shown schematically, but the generation method of output control data is not limited to this. For example, it may also be possible for the control unit 144 to generate output control data by inputting a plurality of pieces of moving image data, which is raw material data, to a learned model created in advance by machine learning or the like, and obtaining output control data output by the learned model.

In a case where a viewer has the right of ownership of the output control data and the raw material data corresponding to the output control data, it is possible for the viewer to appreciate a plurality of moving images as one moving image based on the output control data. Further, in a case where the raw material data is moving image data with sound data, it is possible to view a plurality of moving images with sound data as one moving image with sound data. Specifically, for example, in a case where the moving image data included in the raw material data is moving image data obtained by synchronous image capturing by a plurality of imaging devices, it is possible for the viewer to appreciate a moving image whose viewpoints are switched using multiple angles based on the output control data.

Here, output control data not including part or the whole of each piece of contents data configuring the raw material data is generated. Due to this, it is possible to provide a viewer with a new reproduction method of contents data based on the raw material data while protecting the right, such as the copyright of the creator of the raw material data. The output control data may include part or the whole of at least one piece of contents data configuring the raw material data. In this scenario, it is sufficient to perform the setting for the blockchain system 2 so that, for example, in a case where the sales transaction of the output control data including part or the whole of at least one piece of contents data configurating the raw material data is made, the relevant equivalent value is paid to the creator of the raw material data. Due to this, it is possible to provide a viewer with a display in which a plurality of moving images seems to be one moving image as a new reproduction method of contents data based on the raw material data while protecting the right, such as the copyright of the creator of the raw material data.

### Modification Example 3 of Embodiment 1

In Embodiment 1, the explanation is given by taking a case as an example where the raw material data is sound data and the contents control device 4 generates output control data indicating the contents in which a synthesized sound signal obtained by synthesizing the rendering results of the raw material data is output and controlled as a time series signal. In contrast to this, in Modification Example 3 of Embodiment 1, an aspect is explained in which the raw material data is data of digital contents used for generating a virtual viewpoint image and the contents control device 4 generates virtual camera path information as output control data. In the following, explanation is given by describing the data of digital contents used for generating a virtual viewpoint image (in the following, called “virtual viewpoint contents”) as “virtual viewpoint data”. The virtual viewpoint image is also called a free viewpoint image and the virtual viewpoint image according to Modification Example 3 of Embodiment 1 is not limited to the image corresponding to the appearance from the virtual viewpoint designated freely (arbitrarily) by a user. For example, in the virtual viewpoint image according to Modification Example 3 of Embodiment 1, an image corresponding to the appearance from the virtual viewpoint selected by a user from among a plurality of candidates, and the like are also included.

The virtual viewpoint image is generated by, for example, a method as follows. First, data of a plurality of images (in the following, called “multi-viewpoint image”) obtained by image capturing from directions different from one another by a plurality of imaging devices is obtained. Following this, from the multi-viewpoint image, the foreground image obtained by extracting the image area corresponding to a predetermined object, such as a person or a ball, as the foreground area, and the background image obtained by extracting the image area other than the foreground image as the background area are obtained. Following this, based on the foreground image, three-dimensional shape data (in the following, called “foreground model”) representing the three-dimensional shape of a predetermined object, and texture data for coloring the foreground model are generated. Further, based on the background image, texture data for coloring three-dimensional shape data (in the following, called “background model”) representing the three-dimensional shape of the background, such as the competition stadium, is generated. Following this, to the foreground model and the background model, the texture based on the texture data is mapped and a virtual viewpoint image is generated by the execution of rendering in accordance with the line-of-sight information. That is, the virtual viewpoint data may include data of the multi-viewpoint image, the foreground model, the background model, the texture data, the viewpoint information and the like.

The generation method of a virtual viewpoint image is not limited to the above-described method and for the generation of a virtual viewpoint image, a well-known method may be used, such as a method of generating a virtual viewpoint image by projection conversion of a captured image without using a three-dimensional model. Further, the viewpoint information is information indicating the position of the virtual viewpoint (in the following, called “virtual viewpoint position”) and the direction of the line-of-sight from the virtual viewpoint (in the following, called “virtual viewpoint orientation”). Specifically, the virtual viewpoint information includes a parameter set including parameters indicating the virtual viewpoint position in the virtual space and parameters indicating the virtual viewpoint orientation in each direction of pan, tilt, and roll. The viewpoint information is not limited to that described above and for example, in the parameter set as the viewpoint information, the width of the visual field at the virtual viewpoint, that is, the parameter indicating the viewing angle may be included. Further, the viewpoint information may include a plurality of parameter sets. For example, the viewpoint information may be information including a parameter set corresponding to each of a plurality of frames configuring a virtual viewpoint image of a moving image and indicating the position and orientation of the virtual viewpoint at each of a plurality of continuous points in time.

The virtual camera is a virtual camera different from the imaging device actually installed around the image capturing area and is a concept for conveniently explaining the virtual viewpoint relating to the generation of a virtual viewpoint image. That is, it is possible to regard the virtual viewpoint image as an image obtained by image capturing by a virtual camera from a virtual viewpoint position set within the virtual space associated with the image capturing area. Consequently, it is possible to represent the position and orientation of the virtual viewpoint as the position and orientation of the virtual camera. In other words, it can be said that the virtual viewpoint image is an image simulating a captured image, which is obtained by image capturing by an imaging device, in a case where it is assumed that the imaging device exists at the position of the virtual viewpoint set within the space. Further, the virtual camera path information is information indicating a change over time in at least one of the position and orientation of the virtual viewpoint, that is, information indicating the contents of transition. By using the virtual camera path information as viewpoint information, data of the virtual viewpoint image as a moving image, that is, an image signal in a time series is output. In order to implement the configuration of Modification Example 3 of Embodiment 1, the use of the concept of the virtual camera is not indispensable. That is, it is only required for at least information representing a specific position within the space and information representing the orientation to be set and for a virtual viewpoint image to be generated in accordance with the set information.

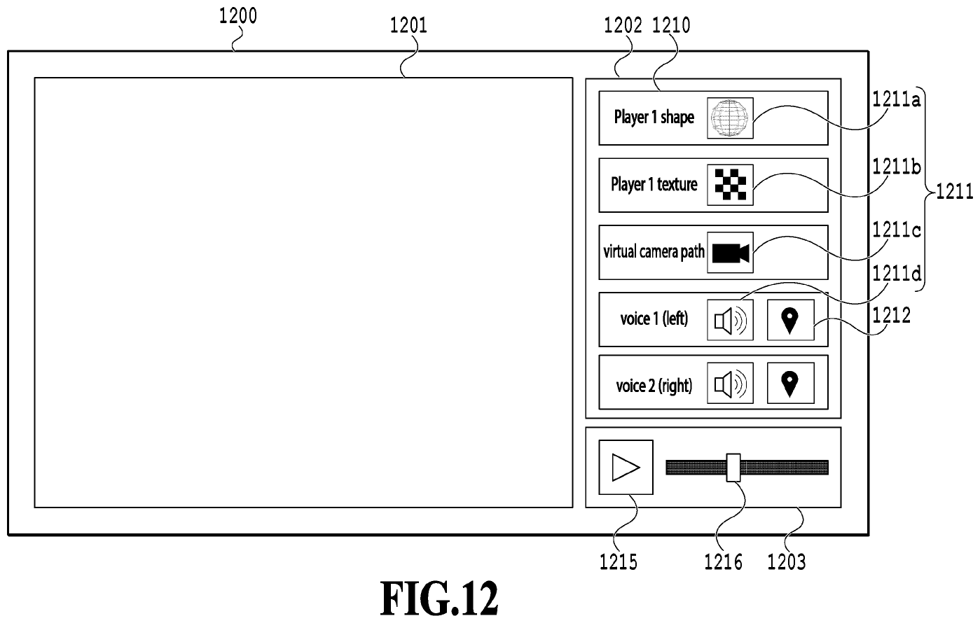

FIG. 12 is a diagram showing one example of a viewing screen 1200 of contents data, which is displayed by the contents control device 4 according to Modification Example 3 of Embodiment 1. The viewing screen 1200 is displayed on the display unit 215 by the processing at S801 shown in FIG. 8 by the contents control device 4. It is possible for a user to perform control to perform listening, appreciation, viewing or the like of the contents included in the contents data owned by him/herself by using the viewing screen 1200. The viewing screen 1200 includes an image display area 1201, a contents selection GUI 1202, and a contents reproduction GUI 1203. The screen configuration of the viewing screen 1200 is the similar as the screen configuration of the viewing screen 900 shown in FIG. 9, and therefore, explanation is omitted. The contents selection GUI 1202 includes an area 1210 in which a contents name is displayed and icons 1211 and 1212.

The icon 1211 indicates the data type of contents data and also plays a role of a button for controlling whether or not to perform rendering. Specifically, an icon 1211a indicates that a foreground model is included in contents data and an icon 1211b indicates that texture data for coloring the foreground model is included in the contents data. Further, an icon 1211c indicates that virtual camera path information is included in the contents data and an icon 1211d indicates that sound data is included in the contents data.

Further, the icon 1212 indicates that information indicating a location is included in metadata corresponding to contents data and also plays a role of a button for controlling whether or not to utilize positional information in a case of rendering of the contents data. The configuration of the contents selection GUI 1202 is the similar as that of the contents selection GUI 902 shown in FIG. 9, and therefore, explanation is omitted. The contents reproduction GUI 1203 includes a button for controlling display output or sound output of contents included in the contents data and a seek bar 1216 for controlling the reproduction time of the contents data. The configuration of the contents reproduction GUI 1203 is the same as that of the contents reproduction GUI 903, and therefore, explanation is omitted.

For example, in a case where a user performs the user operation to select virtual camera path information, the control unit 144 of the contents control device 4 identifies contents data used for viewing and the like based on the user operation. Further, in a case where a user performs the user operation for the button 1215, the virtual camera path information, the foreground model, and the texture data are transmitted to the video generation unit 145 and the video generation unit 145 generates a virtual viewpoint image based on these pieces of information and data. Further, the virtual camera path information and the sound data are transmitted to the sound generation unit 146 and the sound generation unit 146 performs rendering of the sound data based on these pieces of information and data and generates a sound signal. The generated signal and sound signal of the virtual viewpoint image are output to the display unit 215 and the voice output unit 216 in synchronization with each other and display output and sound output are performed.

In the generation of the sound signal in the sound generation unit 146, the virtual camera path information is not indispensable. However, in the virtual camera path information, information indicating the position and orientation of the virtual viewpoint at each point in time is included. Because of this, for example, in a case where information on each sound collection position is included in the metadata of each piece of sound data, which is the base of the synthesized sound signal, it is possible for the sound generation unit 146 to generate a synthesized sound signal by taking the position of the virtual viewpoint as the listening position. Specifically, the sound generation unit 146 generates a synthesized sound signal at the listening position by taking into consideration the delay in sound due to the propagation of the sound wave from the sound collection position to the listening position, the attenuation of the sound wave duet to the propagation and the like. Due to this, it is possible for a user to listen to the sound whose feeling of being at a live performance is stronger in concert with the virtual viewpoint image.

Further, in a case where the voice output unit 216 is capable of performing stereo or surround sound output, it may also be possible for the sound generation unit 146 to generate a stereo sound signal and the like by using the information on the sound collection position of each piece of sound data and the information on the position and orientation of the virtual viewpoint included in the virtual camera path information. The generation method of a stereo sound signal is well known, and therefore, explanation is omitted. Due to this, it is possible for a user to listen to a sound whose feeling of being at a live performance is stronger in concert with the virtual viewpoint image. The signal that is generated by the sound generation unit 146 is not limited to the stereo sound signal and for example, it may also be possible to generate a binaural sound signal.

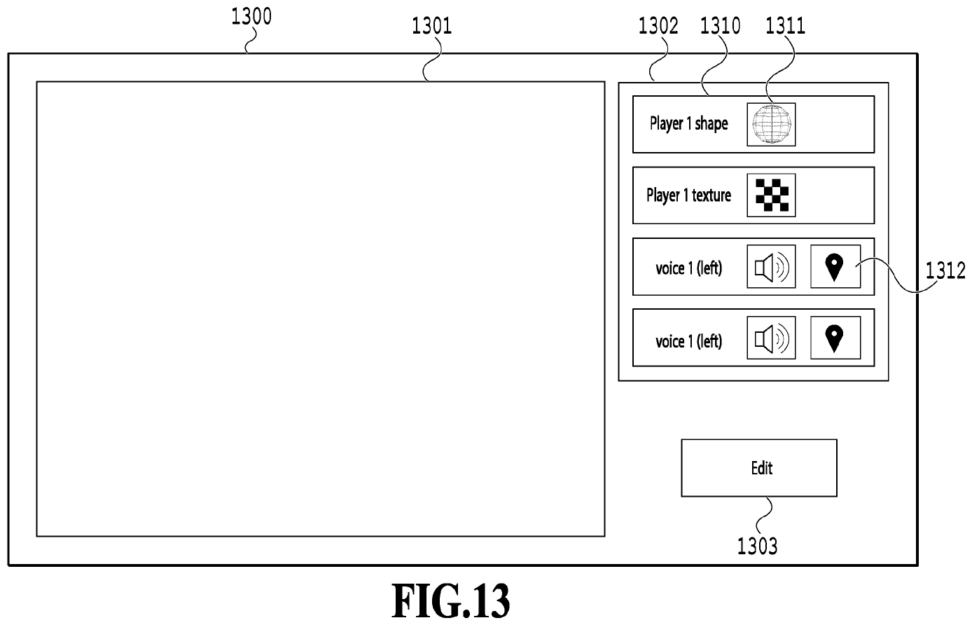

FIG. 13 is a diagram showing one example of a generation screen 1300 of contents data, which is displayed by the contents control device 4 according to Modification Example 3 of Embodiment 1. It is possible for a user to perform editing of output control data based on the contents data owned by him/herself by using the generation screen 1300. Specifically, it is possible for a user to perform editing of virtual camera path information based on raw material data used for the generation of a virtual viewpoint image by using the generation screen 1300. The generation screen 1300 includes an image display area 1301, a contents selection GUI 1302, and an editing button 1303. The contents selection GUI 1302 includes an area 1310 in which a contents name is displayed, a button 1311 for selecting contents data used in a case of editing of output control data, and a button 1312 controlling whether nor not to utilize positional information in a case of editing of output control data. The screen configuration of the generation screen 1300 is the same as the screen configuration of the generation screen 1100 shown in FIG. 11, and therefore, explanation is omitted.

At S1002, a user performs the user operation to select contents data used in a case of editing of output control data and the contents control device 4 identifies the selected contents data based on the user operation. Specifically, a user presses down a button 1311 corresponding to the foreground model and texture data. It may also be possible for a user to designate sound data to be output as sound in a case of appreciating a virtual viewpoint image by pressing down the button 1311 corresponding to sound data, in addition to the button 1311 corresponding to the foreground model and texture data.

In a case where the editing button 1303 is pressed down by a user, at S1003, the display control unit 140 of the contents control device 4 causes the display unit 215 to display an editing screen of a virtual camera path. For example, a user sets the position and orientation of the initial virtual viewpoint used in a case where a virtual viewpoint image is generated on an editing screen not shown schematically. The setting of the position and orientation of a virtual viewpoint is performed, for example, as follows.

First, the video generation unit 145 of the contents control device 4 generates a virtual viewpoint image corresponding to the appearance of an object in a virtual space based on the position and orientation of the virtual viewpoint set in advance based on the foreground model and texture data selected by a user. Further, the display control unit 140 displays the virtual viewpoint image generated by the video generation unit 145 on the editing screen. A user changes the virtual viewpoint to a desired position and orientation by operating a mouse, a keyboard, a joystick or the like and sets the position and orientation of the initial virtual viewpoint. Following this, a user sets the position and orientation of the virtual viewpoint after a predetermined period of time elapses. The setting method of the position and orientation of the virtual viewpoint after a predetermined period of time elapses is the same as the setting method of the position and orientation of the initial virtual viewpoint, and therefore, explanation is omitted. A user sets the position and orientation of the virtual viewpoint at a plurality of discrete points in time by repeating the setting of the position and orientation of the virtual viewpoint each time the predetermined period of time elapses.

The position and orientation of a virtual viewpoint are not limited to the setting of the position and orientation of a virtual viewpoint at a plurality of discrete points in time and the position and orientation of a virtual viewpoint may be set by a locus or the like of the movement of the position and orientation of a virtual viewpoint based on the operation by a mouse or the like. In a case where a storage button, a completion button or the like is pressed down by the user operation on the editing screen not shown schematically, at S1004, the control unit 144 of the contents control device 4 generates virtual camera path information as output control data, which corresponds to the position and orientation of the virtual viewpoint set so far. In a case where the position and orientation of a virtual viewpoint at a plurality of discrete points in time are set, it may also be possible for the control unit 144 to generate virtual camera path information corresponding to a locus linearly or nonlinearly connecting these positions and orientations of the virtual viewpoints. Further, in the above, explanation is given on the assumption that the virtual camera path information is generated based on the editing operation of a user using the editing screen not shown schematically, but the generation method of virtual camera path information is not limited to this. For example, it may also be possible for the control unit 144 to generate virtual camera path information by inputting a foreground model, which is raw material data, and the like to a learned model created in advance by machine learning or the like, and obtaining virtual camera path information output by the learned model.

After S1004, by performing the processing of the sequence diagram shown in FIG. 3 by taking the generated virtual camera path information as registration-target contents data, the virtual camera path information is registered in the database system 1. Further, by performing the processing of the sequence diagram shown in FIG. 5, the sale status of the virtual camera path information is set in the blockchain system 2. Due to this, the virtual camera path information is made public in the state where transfer to a viewer including the owner of the raw material data is possible.

In a case where a viewer has the right of ownership of the virtual camera path information, which is output control data, and the foreground model and the texture data, which are the raw material data corresponding to the output control data, it is possible for the viewer to perform the display output of the virtual viewpoint image based on the virtual camera path information. Here, the virtual camera path information does not include part or the whole of the foreground model and the texture data, which are the raw material data. Because of that, it is possible to provide a virtual viewpoint image based on virtual camera path information while protecting the right, such as the copyright of the creator of the raw material data. Further, as described above, it is also possible to generate a synthesized sound signal by using virtual camera path information. Due to this, it is possible for a viewer to listen to synthesized sound whose listening position is the position of a virtual viewpoint in concert with the virtual viewpoint image. That is, it is possible for a viewer to view the virtual viewpoint image with synthesized sound, and due to this, it is possible to view the virtual viewpoint image whose feeling of being at a live performance is stronger.

### Embodiment 2

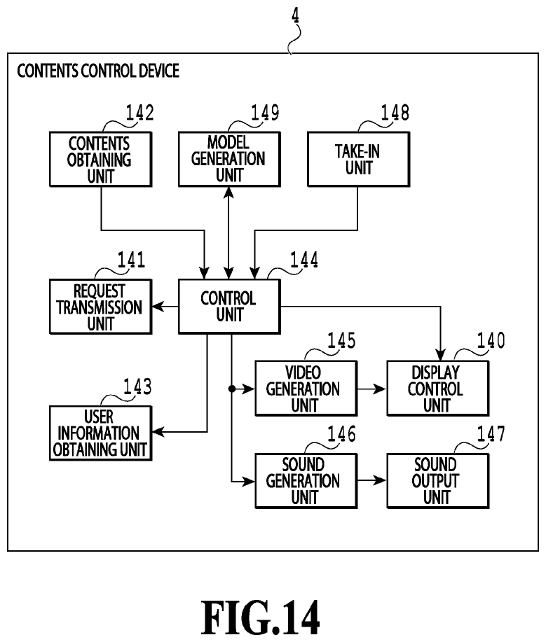

In Embodiment 1 and each Modification Example of Embodiment 1, the aspect is explained in which the contents control device 4 generates the output control data indicating the contents in which rendering results of raw material data are output and controlled as a time series signal. In contrast to this, in Embodiment 2, an aspect is explained in which raw material data is data of a multi-viewpoint image and the contents control device 4 generates a foreground model. FIG. 14 is a diagram showing one example of the function configuration of the contents control device 4 according to Embodiment 2 (in the following, simply described as “contents control device 4”). The contents control device 4 is applied to the information processing system and the information processing system according to Embodiment 2 has the database system 1, the blockchain system 2, the contents provision device 3, and the contents control device 4. The database system 1, the blockchain system 2, and the contents provision device 3 according to Embodiment 2 are the similar as each corresponding system or device according to Embodiment 1, and therefore, explanation is omitted.

The contents control device 4 has the display control unit 140, the request transmission unit 141, the contents obtaining unit 142, the user information obtaining unit 143, the control unit 144, the video generation unit 145, the sound generation unit 146, the sound output unit 147, the take-in unit 148, and a model generation unit 1449. The contents control device 4 has the hardware configuration shown in FIG. 2 and each unit that the contents control device 4 has as the function configuration is implemented by the control of the whole contents control device 4 by the CPU 211. The the display control unit 140, the request transmission unit 141, the contents obtaining unit 142, the user information obtaining unit 143, the control unit 144, the video generation unit 145, the sound generation unit 146, the sound output unit 147, and the take-in unit 148 are the same as each corresponding unit according to Embodiment 1, and therefore, explanation is omitted. The model generation unit 1449 generates three-dimensional shape data (foreground model) indicating a three-dimensional shape of an object captured in a captured image by using data of a multi-viewpoint image as raw material data.

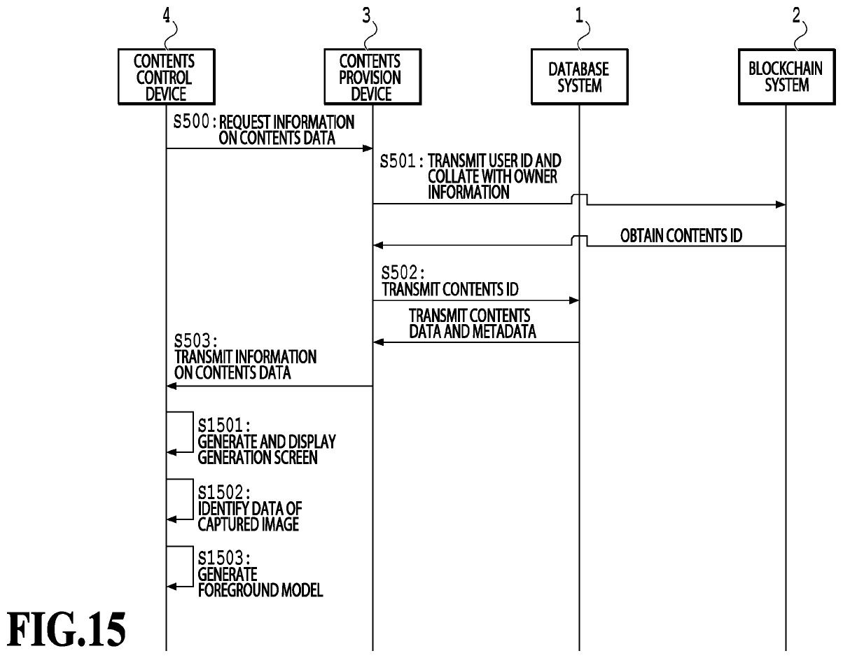

FIG. 15 is a sequence diagram showing one example of a flow of processing of the information processing system according to Embodiment 2 and is a sequence diagram showing a flow of processing of the information processing system in a case where a foreground model is generated. First, in the information processing system, the same processing as the processing at S500 to S503 shown in the sequence diagram in FIG. 5 is performed. After S503, at S1501, the contents control device 4 generates a generation screen for generating a foreground model by using the data of an image showing the metadata received at S503 and causes the display unit 215 to display the generation screen. On the generation screen generated at S1501, data of a plurality of captured images included in the data of the multi-viewpoint image owned by a user is displayed in a list.

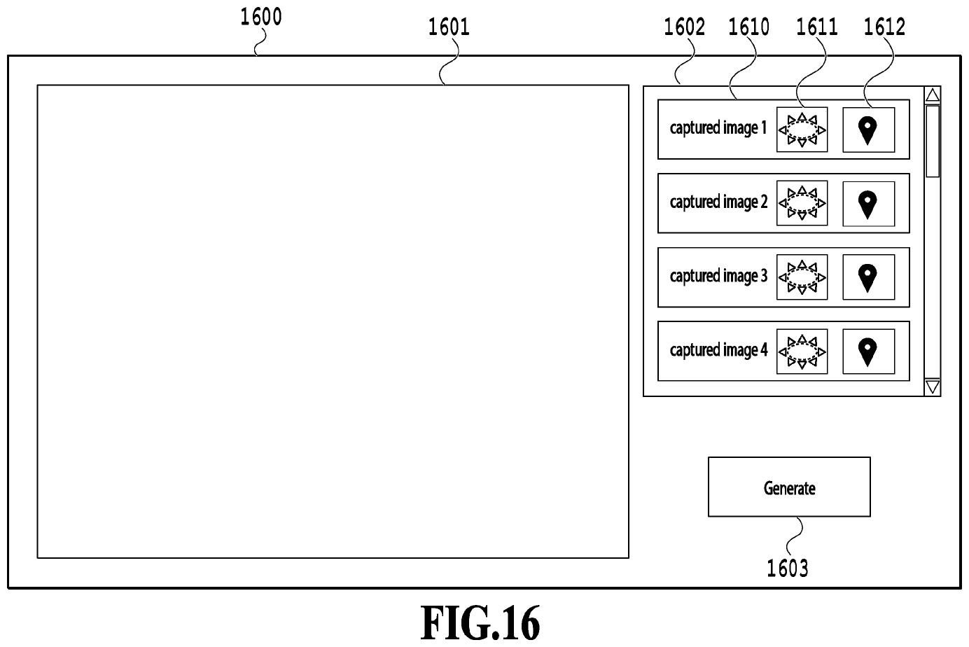

FIG. 16 is a diagram showing one example of a generation screen 1600 for generating a foreground model, which is displayed by the contents control device 4 according to Embodiment 2. It is possible for a user to generate a foreground model based on data of a multi-viewpoint image owned by him/herself by using the generation screen 1600. The generation screen 1600 includes an image display area 1601, a contents selection GUI 1602, and a Generate button 1603. The contents selection GUI 1602 includes an area 1610 in which a contents name is displayed and icons 1611 and 1612. The icon 1611 indicates the data type of contents data and also plays a role of a button for selecting whether or not to use as raw material data in a case where a foreground model is generated. Specifically, the icon 1611 indicates that the contents data is data of a captured image configuring data of a multi-viewpoint image. Further, the icon 1612 indicates that information indicating the image capturing position, that is, the position of the imaging device corresponding to the captured image is included in the metadata corresponding to the data of the captured image.

After S1501, at S1502, a user performs the user operation to select data of a captured image used for the generation of a foreground model from among the data of a plurality of captured images included in the data of the multi-viewpoint image and the contents control device 4 identifies the selected data of the captured image. In a case where the Generate button 1603 is pressed down by a user, at S1503, the model generation unit 1449 of the contents control device 4 generates a foreground model based on the captured image data selected at S1502. Specifically, the model generation unit 1449 first extracts the foreground image and the background image from each captured image based on the selected data of the plurality of captured images. Following this, the model generation unit 1449 generates a foreground model indicating the three-dimensional shape of a predetermined object based on the foreground image. As above, according to the contents control device 4, it is possible for a user to generate a foreground model as new contents data by using the data of the multi-viewpoint image owned by him/herself as the raw material data. The generation method of a foreground model using a foreground image is well known, and therefore, explanation is omitted. Further, the model generation unit 1449 generates texture data for coloring the generated foreground model based on the foreground image. As above, according to the contents control device 4, it is possible for a user to generate texture data for coloring the foreground model as new contents data by using the data of the multi-viewpoint image owned by him/herself as raw material data.

After S1503, by performing the processing of the sequence diagram shown in FIG. 3 by taking the generated foreground model and texture data as registration-target contents data, these pieces of contents data are registered in the database system 1. Further, by performing the processing of the sequence diagram shown in FIG.5, the sale status of the foreground model and the texture data is set to the blockchain system 2. Due to this, the foreground model and the texture data are made public to a viewer including the owner of the raw material data. It is possible for a viewer to appreciate a virtual viewpoint image by using the foreground model and the texture data. It may also be possible for the creator of the foreground model and the texture data to generate virtual camera path information by the method explained in Modification Example 3 of Embodiment 1 and make public the generated virtual camera path information to a viewer along with the foreground model and the texture data.

The foreground model does not include at all the data of the multi-viewpoint image used as the raw material data. Because of that, it is possible to provide a viewer with the foreground model based on the raw material data while protecting the right, such as the copyright of the creator of the data of the multi-viewpoint image, which is the raw material data. The texture data may be one including information on part of the data of a captured image or one not including at all the data of a captured image. The texture data not including at all the data of a captured image is, for example, described in markup language, such as XML, and includes information indicating the crop position the captured image, the transformation method of a cropped image area, the corresponding point between the foreground model and the image area, and the like. The texture data such as this does not at all include the data of a captured image. Because of that, in a case where a viewer owns the data of the multi-viewpoint image, the texture data, and the foreground model, it is possible for the viewer to appreciate a virtual viewpoint image while protecting the right, such as the copyright of the creator of the data of the multi-viewpoint image, which is the raw material data.

Further, in a case where the texture data includes information on part of the data of a captured image, it is sufficient to perform the setting for the blockchain system 2 so that in a case where the sales transaction of the texture data is made, the relevant equivalent value is paid to the creator of the data of the multi-viewpoint image, which is the raw material data. Due to this, it is possible to make public the texture data including information on part of the data of a captured image to a viewer while protecting the right, such as the copyright of the creator of the raw material data.

### Other Embodiments

Some embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, it is possible to generate new contents data by using a plurality of pieces of contents data owned by a user as raw material data.

While the present disclosure has described exemplary embodiments, it is to be understood that some embodiments of the disclosure are not limited to the disclosed exemplary embodiments. The scope of the following claims is to be accorded the broadest interpretation so as to encompass all such modifications and equivalent structures and functions.

This application claims priority to Japanese Patent Application No. 2023-72276, which was filed on Apr. 26, 2023 and which is hereby incorporated by reference wherein in its entirety.

What is claimed is:

1. An information processing apparatus comprising:
one or more processors; and
one or more memories storing one or more programs configured to be executed by the one or more processors, the one or more programs including instructions to:
obtain user information indicating a user;
obtain a plurality of pieces of contents data whose current owner is the user based on the user information; and
generate output control data indicating contents in which rendering results of at least two pieces of contents data among the plurality of pieces of contents data are output and controlled as a time series signal.

2. The information processing apparatus according to claim 1, wherein
the output control data includes contents identification information for identifying each of the at least two pieces of contents data.

3. The information processing apparatus according to claim 1, wherein
the output control data is described in markup language.

4. The information processing apparatus according to claim 1, wherein
the output control data does not include part or the whole of each piece of contents data in the at least two pieces of contents data.

5. The information processing apparatus according to claim 1, wherein
each of the at least two pieces of contents data is sound data different from each other and
the output control data indicates contents in which a synthesized sound signal obtained by synthesizing the rendering results of at least two pieces of sound data in synchronization is output and controlled as the time series signal.

6. The information processing apparatus according to claim 5, wherein
each of the at least two pieces of sound data includes sound collection position information indicating a position at which sound indicated by sound data is collected and
the output control data includes listening position information indicating a position at which sound corresponding to the synthesized sound signal is listened to.

7. The information processing apparatus according to claim 5, wherein
the output control data includes synchronization information used in a case where the rendering results of the at least two pieces of sound data are synchronized with each other as contents in which the synthesized sound signal is output and controlled as the time series signal.

8. The information processing apparatus according to claim 5, wherein
the output control data includes synthesis information used in a case where the rendering results of the at least two pieces of sound data are synthesized as contents in which the synthesized sound signal is output and controlled as the time series signal.

9. The information processing apparatus according to claim 1, wherein
each of the at least two pieces of contents data is image data different from each other and
the output control data includes information indicating timing at which the rendering results of each of at least two pieces of image data are output and controlled as contents output and controlled as the time series signal.

10. The information processing apparatus according to claim 1, wherein
at least one of the at least two pieces of contents data is data for virtual viewpoint image capable of generating a virtual viewpoint image and
the output control data includes virtual camera path information indicating a transition in position and orientation of a virtual viewpoint, which is used in a case where the virtual viewpoint image is generated, as contents output and controlled as the time series signal.

11. The information processing apparatus according to claim 10, wherein
the data for virtual viewpoint image is three-dimensional shape data indicating a three-dimensional shape of an object.

12. The information processing apparatus according to claim 11, wherein
the three-dimensional shape data is data obtained by coloring the three-dimensional shape.

13. The information processing apparatus according to claim 10, wherein
the at least two pieces of contents data include three-dimensional shape data indicating a three-dimensional shape of an object and texture data for coloring the three-dimensional shape as the data for virtual viewpoint image.

14. The information processing apparatus according to claim 1, wherein
the one or more programs further include instructions to:
output and control the rendering results of the at least two pieces of contents data as the time series signal based on the output control data in a case where the user is a current owner of the output control data and the at least two pieces of contents data in which the rendering results are output and controlled as the time series signal by the output control data.

15. An information processing method comprising the steps of:
obtaining user information indicating a user;
obtaining a plurality of pieces of contents data whose current owner is the user based on the user information; and
generating output control data indicating contents in which rendering results of at least two pieces of contents data among the plurality of pieces of contents data are output and controlled as a time series signal.

16. A non-transitory computer-readable storage medium storing a program for causing a computer to perform:
obtaining user information indicating a user;
obtaining a plurality of pieces of contents data whose current owner is the user based on the user information; and
generating output control data indicating contents in which rendering results of at least two pieces of contents data among the plurality of pieces of contents data are output and controlled as a time series signal.
